(19) United States
(12) Patent Application Publication
(10) Pub. No.: US 2019/0316352 A1
(43) Pub. Date: Oct. 17, 2019

(54) Wall/Roof Construction System and Related Method

(71) Applicant: John F. Brooks, III, Fairmount City, PA (US)

(72) Inventor: John F. Brooks, III, Fairmount City, PA (US)

(21) Appl. No.: 16/138,794

(22) Filed: Sep. 21, 2018

Related U.S. Application Data
(60) Provisional application No. 62/658,818, filed on Apr. 17, 2018.

(51) Int. Cl. E04C 2/28; E04C 2/296; B32B 21/06; B32B 7/12; B32B 7/06; B32B 3/06

(52) U.S. Cl. CPC E04C 2/28; E04C 2/296; B32B 21/06; B32B 7/12; B32B 7/06; B32B 2607/00; B32B 2307/7246; B32B 2307/304; B32B 2255/12; B32B 2255/26; B32B 3/06

(57) ABSTRACT

This invention comprises a wall or roof sheathing with purposefully overlapping barriers along at least one lateral edge, preferably along two adjacent lateral edges and, most preferably, along all four lateral sides to a given sheet product hereunder. This system has moisture permeability and results in an improved installation method. The system comprises both structural and nonstructural panels, either insulated or non-insulated, in the form of wall and/or roof sheeting.

### CROSS-REFERENCE TO RELATED APPLICATIONS

This is a perfection of U.S. Provisional Application Ser. No. 62/658,818, filed on Apr. 17, 2018, the disclosure of which is fully incorporated by reference herein.

### FIELD OF THE INVENTION

This invention pertains to sheeting systems (both structural and nonstructural) for insulated or non-insulated wall and roof systems. Particularly, this construction system incorporates a water resistive barrier to sheeting layer that enables the water resistive barrier to be installed in a top-over-bottom overlapping fashion for managing top or side bulk water. Further preferred versions of this invention also possess an ability to serve as an air barrier.

### BACKGROUND OF THE INVENTION

In residential and commercial construction, sheeting is typically attached over the building's framework. Such sheeting is typically installed in horizontal rows with reoccurring row joints being purposefully staggered. After the sheeting layers are installed, a water resistive barrier is usually applied thereabout to protect against bulk water penetration. See, prior art FIGS. 1A-C for examples of several known barrier layer application techniques.

There are many different types of water resistant barriers but most take additional time and labor to install. Some applications of barrier layers can also be quite difficult to apply or handle in adverse weather conditions. Several popular water resistant barriers are made and sold in roll forms that take two to three people to install. The present invention, by contrast, can be installed with one or two men in only one trip about the building with very little labor and no additional set up time.

Some structural and nonstructural sheeting products qualify as a water resistive barrier by physically taping the seams after all of the individual panels are installed thus requiring two trips around the building. See, FIGS. 1A and B. Some known sheet products have a water resistant barrier added to the exterior skin of a wood, wood/composite core like Huber ZIP system or Georgia Pacific's ForceField. Note, however, that the outer skins to such panel products are sized the exact same as the panels themselves, i.e. with absolutely no overlap whatsoever. Others are composed of an insulated material that is water resistant the whole way through such as XPS insulation. Still others have a water resistant skin like EPS or Polyiso. All of the foregoing systems still suffer from a common major fail point, which is the source to a lot of controversy in today's building industry. Taping the horizontal seams goes against all good building practices because it creates a reverse lap (i.e., where the lower layer overlaps the upper layer leaving an upward facing seam). That, in turn, leads to water intrusion into the structure. By merely taping horizontal joints, one is relying on perfect lab quality installations with a further expectation that the adhesives to such joint tapes will never break down. Even when properly installed, such things as dust, dirt, mud, and/or oil from the installer's hands can cause most any reverse joint to fail prematurely. Once the upper edges of such taped joints fail, those edges become a water collection point. Rather than being redirected away, this water will tend to seep into the structure, at these seams, leading to mold, mildew, and structural rot. While the horizontal joints in the foregoing applications are not taped, there is no reverse shingling that happens in the horizontal direction(s).

There was found a patented product for flexibly wrapping around pipe, that product showing some overlap on two sides for joining to itself (i.e. the same sheet, as opposed to adjoining sheets). But the product of U.S. Pat. No. 6,403,182 was never intended to serve as an air OR WATER barrier around the pipe it wrapped. It was merely a pre-shaped curvature of insulation with some overlapping for joining to itself after being installed about a section of circular piping.

### BRIEF SUMMARY OF THE INVENTION

This invention comprises a wall or roof sheathing with purposefully overlapping barriers along at least one lateral edge, preferably along two adjacent lateral edges and, most preferably, along all four lateral sides to a given sheet product hereunder. This system has vapor/moisture permeability unless used for hot, humid climates. In the latter instances, the preceding permeability would be replaced with inclusion of a vapor barrier layer. In either case, an improved installation method results. The system comprises both structural and nonstructural panels, either insulated or non-insulated, either as a foamed in insulation layer, or more commonly, in the form of wall and/or roof sheeting.

Each panel under this invention has an intentionally overlaying water resistant barrier bonded permanently to the panel, that overlaying barrier being wider and/or longer than the sheeting to which it is attached (or pre-attached).

When the individual sheets of this invention are installed, the purposefully overlapping water resistant barrier sections along one, two, three or all four lateral edges of such sheeting, with the understanding that only two adjoining panel joints need to be minimally overlapping. For situations where three or all four edges are overlapping, it is preferred that one horizontal (and possibly one of the two vertical) extending joint overlaps be trimmed or cut away upon panel installation (i.e. before the next panel sheet is installed above it and/or to its right (or left)) so as to not risk creating any areas of unsecured barrier layer overlaps behind which moisture/water may accumulate. See, for example, the cutaway preferences spelled out in the accompanying FIG. 9 installation instructions.

With that overlap at the area-critical joints, this invention will enable shedding water in a shingling effect. Particularly, each upper layer of sheeting that overlaps its lower layers there beneath, will always direct bulk water down and away from the building and into the drainage plane using gravity to move waters away from adjacent panel joints. Through the application of an adhesive to such overlaps, this invention can further serve as an air barrier.

### SUMMARY OF THE DRAWINGS

Further features, objectives and advantages of this invention will become clearer with the following detailed description made with reference to the accompanying photographs in which:

FIG. 1A is a front plan view of a first prior art system of taping over the seams of adjoining structural panels for water seepage prevention;

FIG. 1B is a front plan view of a second prior art system of taping over the seams of adjoining insulation sheets for water seepage prevention;

FIG. 1C is a front plan view of a third prior art system that staples (or nails) waterproofing papers, in a shingling manner, over the outside of a paneled structure;

FIG. 2 is a side perspective view of one embodiment of construction panel according to the present invention, this view showing its overlap with adjacent panels;

FIG. 3 is a top plan view of the rearmost panel from FIG. 2;

FIG. 4 is a bottom plan view of the same panel from FIG. 3;

FIG. 5 is a side plan view of that same representative panel;

FIG. 6 is a top plan view of a first alternative of this invention which has overlap on only 3 of its four lateral edges;

FIG. 7 is a top plan view of a second alternative, that shows a panel of this invention with the least amount of panel overlaps, i.e. on two (adjacent) of its four lateral edges;

FIG. 8 is a top plan view of a third alternative showing a barrier layer, panel overlap along just one lateral side of the panel; and

FIG. 9 is a front plan view showing one preferred method of multiple panel installations with preferred trimming directions for excess adjacent overlaps.

### DESCRIPTION OF PREFERRED EMBODIMENTS

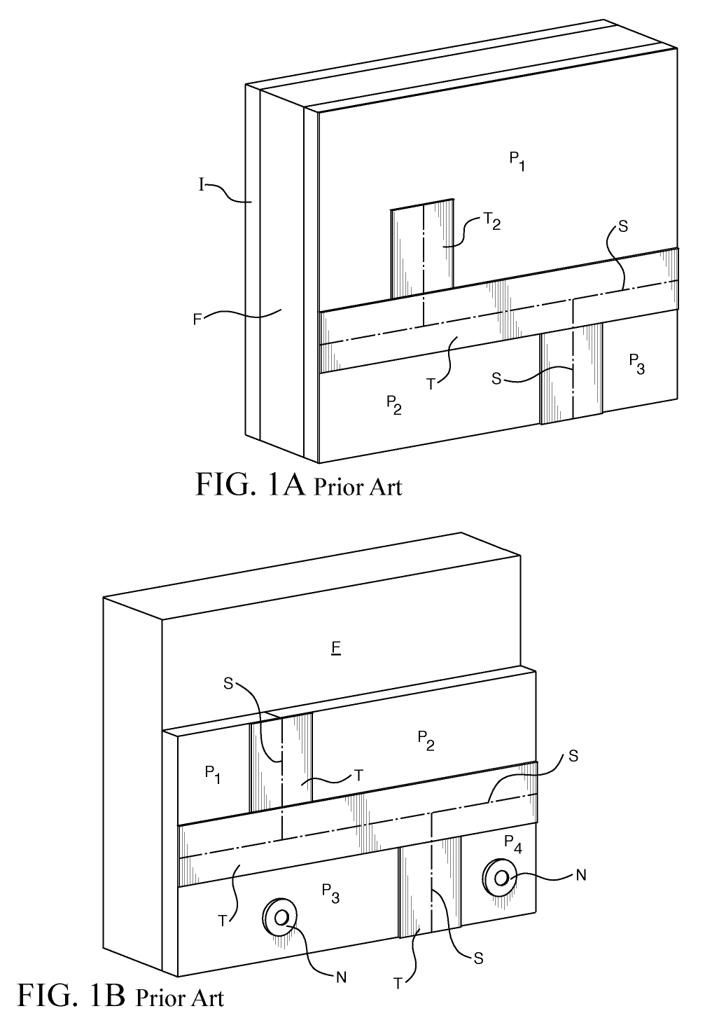

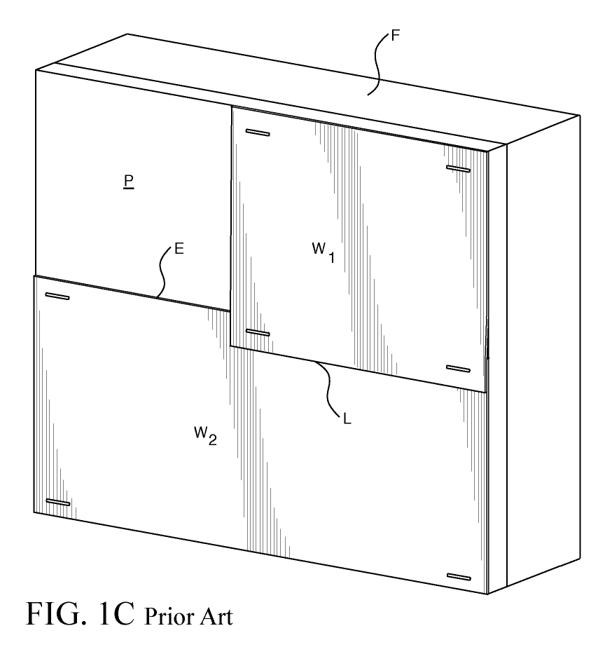

In properly installed water resistant barriers, gravity is the driving force behind drainage. Unfortunately, gravity is also the driving force for failure in the taped systems of the Prior Art (as in FIGS. 1A and B) and papered over coverings of Prior Art FIG. 1C. Particularly therein, FIG. 1A shows a representative section of wall framing F to which is mounted a first exterior wall panel P₁, a second panel P₂ and a third exterior panel P₃. To the inside of this same framing F would be mounted a section of interior drywall I in some instances. As is known in the art, builders routinely apply a length of waterproof taping T to fully cover the seams (shown with dashed lines S in FIG. 1A) between adjacent panels. Sometimes additional taping T₂ is used to cover possible tears or damaged areas of a given wall panel, often at or near the panel's edge.

In Prior Art FIG. 1B, another view of seam taping T is shown on adjacent wall panels P₁, P₂, P₃ and P₄ that may be adhered to the underlying framing F, as is the case with uppermost panels P₁ and P₂, OR mechanically secured to the framing F, as is the case with the securement screws or nails N used to affix lower down panels P₃ and P₄ to framing F before their respective seams S are covered with taping T in a time and labor intensive, second step/pass operation about the entire construction exterior.

Prior Art FIG. 1C shows another known alternative (already in practice). Therein, panels P to the exterior of framing F are first covered over, with adjoining sections of waterproof papers W₁ and W₂, in a knowing, purposeful shingle-style pattern, namely, that each lower waterproof paper has its uppermost edge E covered with the lowermost edge L of the section of waterproof paper W directly above it in order for any water that may get behind the building's outermost siding layer (not shown) to flow “downhill” with gravity. These respective sections of waterproof paper W₁, W₂ are then stapled or nailed to the framing F.

The properly shingled panels of this invention do not rely on tape for sealing out moisture. The larger water-resistant barriers (above) overlaps the sheeting layers below and to the sides making for a proper shingle fashion installation.

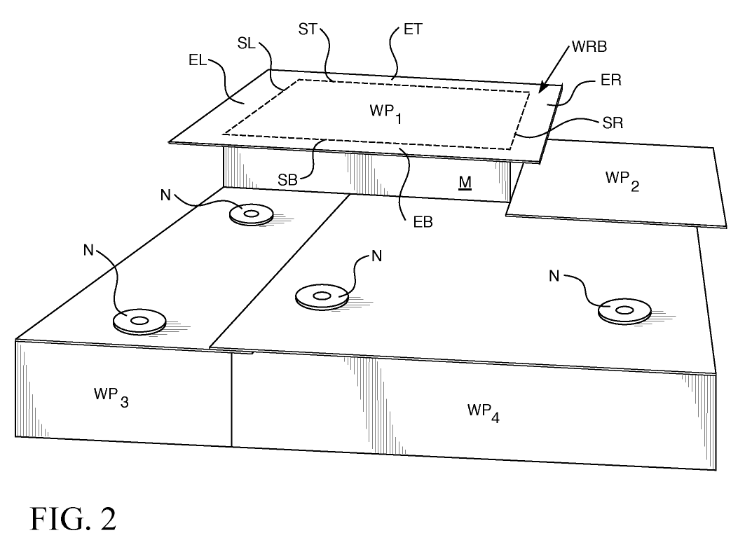

Referring now to FIGS. 2 through 5, there is shown a first preferred embodiment of the present invention. It consists of a wall panel WP₁ for attaching to a building wall (or roof, in another variation of this invention) frame/framing (not seen in this view). Wall panel WP₁ consists of an underlayment of wall panel material M (sheeting, wood, insulation (either foamed OR sheet), fiberglass-faced gypsum sheathing, etc.) onto which is affixed (by gluing, nailing or stapling) an oversized sheet of water resistant barrier product WRB. Wall panel WP1, would be fitted, somewhat like a puzzle piece, so that its overlapping edges EL (left), ER (right), ET (top) and EB (bottom) will completely cover the water resistant barrier layers of adjoining wall panels WP₂, WP₃ and WP₄. The lower of these 3 wall panels are shown with nails N for securing to an underlying frame but it is understood that the wall panels of this invention may be attached by numerous known (or even subsequently developed) panel attaching means.

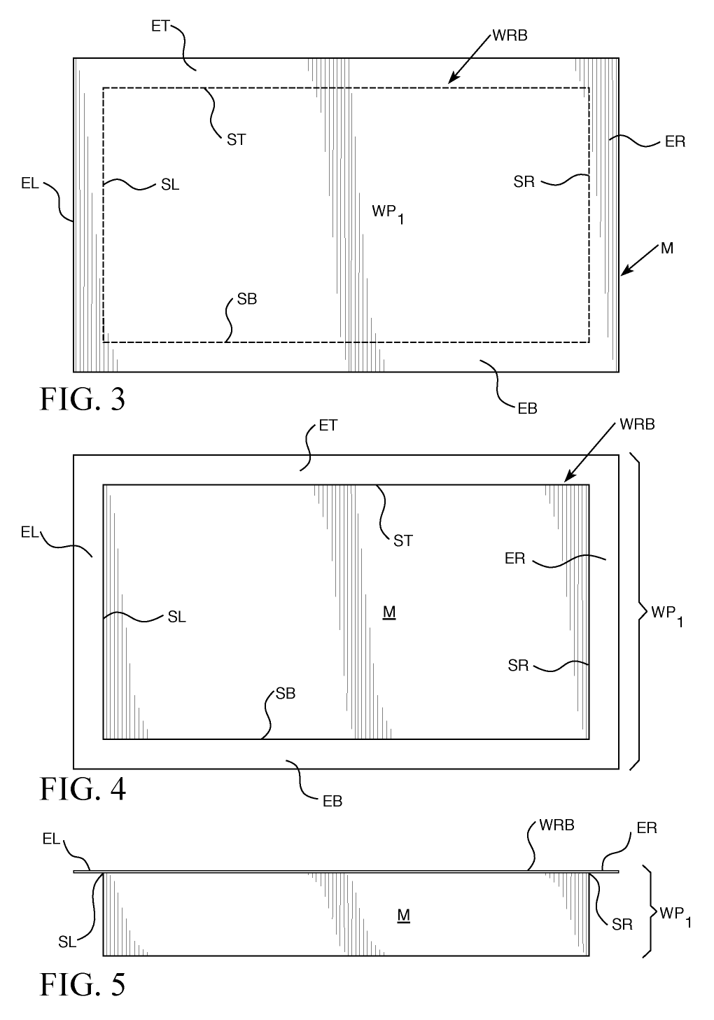

For underscoring the value of overlapping edges EL, ER, ET and EB for this first embodiment of the invention, the actual perimeter of the wall panel material M in the section of wall panel WP₁ being installed is illustratively marked with dashed lines SL, SR, ST and SB. The same carries over for the individual panel (with adjoining sections removed for better illustration) as found at FIGS. 3, 4 and 5 (from the respective top, bottom and side plan views.

On a preferred basis, each panel hereunder overlaps its adjoining panels by a minimum of ¾ inch, more preferably about a 1 to 1¾ or even 2 inches. Depending on the sealants employed, such panel overlaps from about 2, 2.5 to 4 inches thick/wide may be prudent.

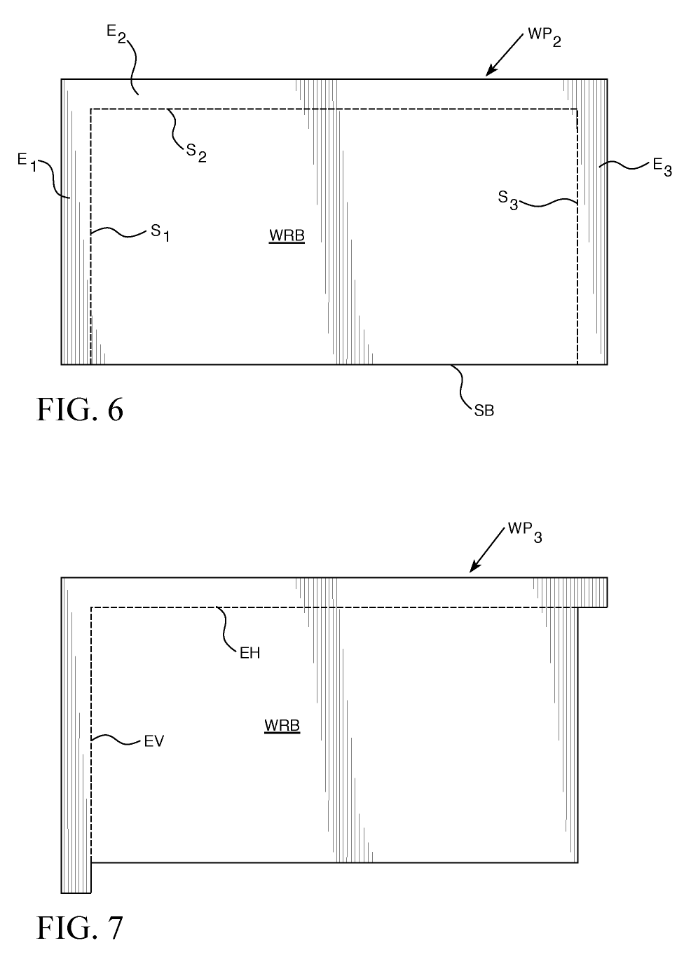

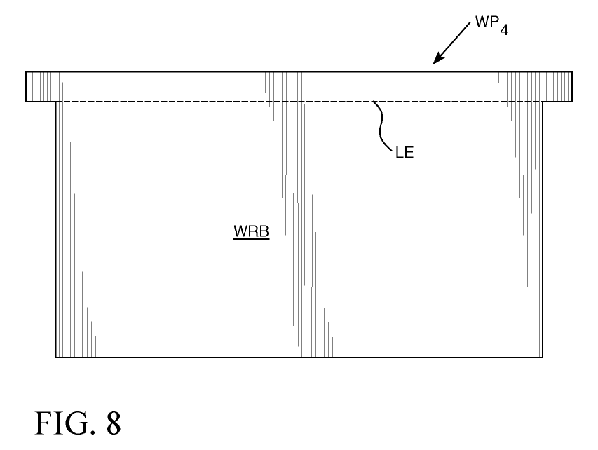

For ease of placing against adjoining panels, overlapping must consistently occur on at least one lateral edge LE of the underlayment material as per the third alternative of wall panel WP₄ shown in FIG. 8. More preferably, overlapping occurs on two edges, preferably adjoining like the one horizontal EH and one vertical EV edge per the second variation of wall panel WP₃ at FIG. 7. Optionally, a three-edge model E₁, E₂ and E₃, along respective panel sides S1, S2 and S3, is also covered by the present invention, as best seen in FIG. 6. It leaves no overlap along only the bottom side SB of that wall panel WP₂. Most preferably, however, each panel product should be overlapping outwardly beyond its underlayment (wood, sheet, insulation) on all four sides/edges (or completely about the full perimeter of said underlayment material).

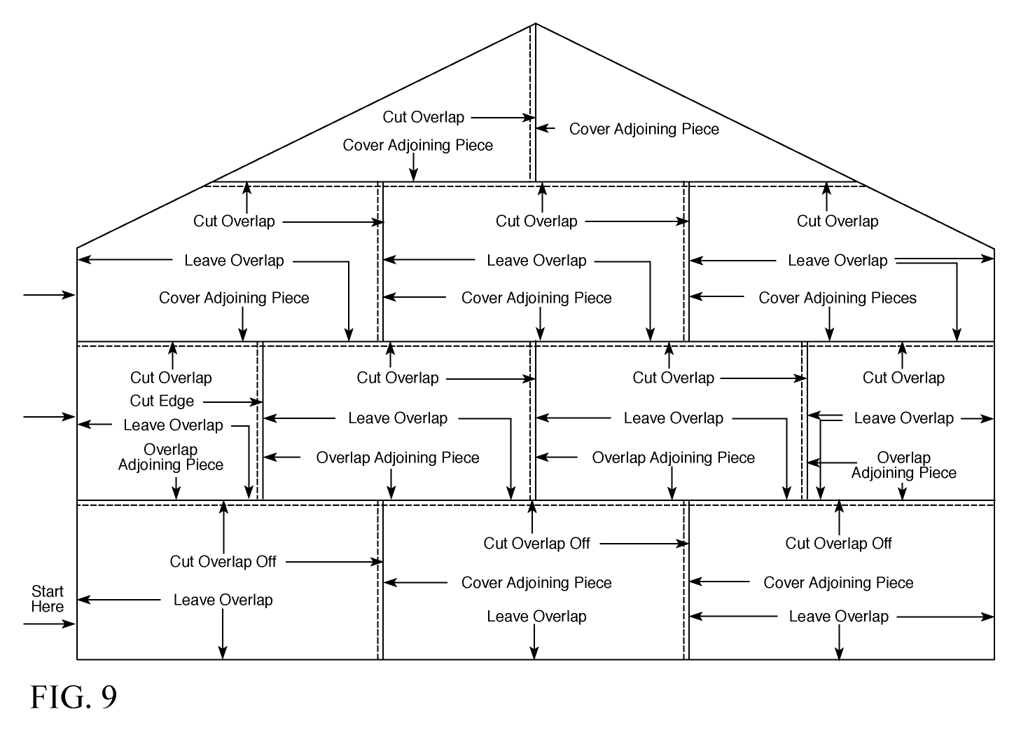

See, FIG. 9 for a preferred method of arranging adjacent panels having overlapping edges on all four sides—and note the preferred removal thereof from the top and right sides (in this installation version) so as to NOT create any regions in which water may creep in and/or flow down through a fully installed sidewall of panels according to this invention.

The section(s) of overlap that serve as the water resistant barrier for this invention may have an adhesive applied (brushed or sprayed) to it right before its on-site installation to a wall or roof structure. Alternately, that adhesive may be pre-applied, i.e., added during the panel's manufacturing process. In the latter case, it is preferred that a protective paper or cellophane strip cover the pre-applied adhesive until ready to apply atop adjoining panel(s) in a shingling manner. When so glued to one another, this embodiment of overlapping panels actually allows the overlapping layers to serve as a de facto air barrier in addition to the water resistant barrier.

Note that in an alternate variation, these same panels can be manufactured without any self-adhesive backing on the overlapping area(s). In that case, such panels would serve more of a properly shingled water resistive barrier (or WRB) only. Building codes require that the WRB layer in a shingle-like fashion. This invention is meant to give a proper installed (shingle fashion) water resistant barrier and sheeting in one product! Other known products that combine a water resistant barrier and sheeting together still require going back after the panels are installed to either tape over the respective panel joints (FIGS. 1A and B) or paper over the entirety in a shingled fashion (FIG. 1C). Unfortunately, the known tape alternative is prone to fail leading to water intrusion. And the latter paper “reapply” is both labor intensive AND time consuming.

The product of this invention allows overlapping seems to be installed contemporaneously, i.e., while installing the sheet panels themselves, giving a better, truer installation and also saving labor/time by not having to do extra trips about a structure to provide subsequent water barrier layers.

The new sheeting mentioned hereinabove will NOT need any extra material like tape (or tapings) to complete the WRB. Accordingly, it should save substantial installation man-hours for the builder and construction costs for the property owner.

In still other variations, the reverse side of these purposefully overlapping panel products may be further covered with a radiant barrier material to reflect energy back into the structure and help reduce the costs of heating/cooling that house. The reflective surface may be applied either by coating or laminating directly to the panels proper.

A video explaining reverse shingling can be found at: http://www.dupont.com/products-and-services/construction-materials/building-envelope-systems/videos/zip-reverse-shingling-vs-tyvek.html

And an article on Exterior Foam Sheathing: Good Insulator, Bad Water Resistive Barrier can be found at: https://www.connormill-built.com/zippity-do-dont/

Any well-seasoned builder knows that to keep water out of a building, one must shed and re-direct water away from that building. Sealants, caulks and adhesives each take a different approach to that problem, sometimes just by plugging the seams, gaps and holes defying water to breach its fortress until that sealant ultimately fails and breaks down (as they always do).

Conventional house wraps shed water in a shingling effect in that their upper layers overlap lower layers to always direct water away from the building and into the drainage plane. Zip Wall tape, no matter how good the adhesive, is essentially a reverse shingle that relies on adhesive to overcome the practical advantage of a shingling overlay. When that adhesive breaks down, however, water plants its flag in the opening created by tape separation, etc., eventually claiming its victory, i.e., the spoils being rotted OSB and framing beyond.

This same reliance on sealant rather than shedding happens at the top of all window and door openings where Zip tape is the last line of defense for the relentless onslaught of water. Admittedly, Zip tape is good as adhesives go. The whole system has a thirty year warranty. But what happens in year thirty-one? If one was using a low quality siding that needs to be replaced every thirty years or less, re-taping of the joints may suffice. But if one is using a higher quality siding, one is in for substantial replacement costs (and possibly mold remediation) when the tape joints fail and that same siding hides the sudden breach of one's tape defense with victorious water starting a permanent hostile occupation there beneath.

Having described the presently preferred embodiments, it is to be understood that this invention may also be addressed by the scope of the following claims:

1. A rectangular construction panel sheeting system comprising an underlayment of base material having a water barrier layer affixed to the underlayment of base material, said water barrier layer overlapping about an entire perimeter of the underlayment of base material by at least about ¾ inch, said overlapping water barrier layer of a first construction panel adapted for covering adjoining edges of one or more second construction panels.

2. The rectangular construction panel system of claim 1, which is suitable for use as a wall underlayment.

3. The rectangular construction panel system of claim 1 wherein the underlayment of base material is structural and selected from the group consisting of wood and sheeting.

4. The rectangular construction panel system of claim 1 wherein the underlayment of base material is insulation.

5. The construction panel system of claim 2 wherein the water barrier layer overlaps the underlayment of base material on at least one horizontally extending lateral edge.

6. The rectangular construction panel system of claim 1 wherein the water barrier layer overlaps the underlayment of base material on all horizontally extending and all vertically extending adjoining construction panel edges.

7. The rectangular construction panel system of claim 1 wherein the water barrier layer overlaps use gravity to move waters away from adjacent panel joints.

8. The construction panel system of claim 1 wherein the water barrier layer overlaps the edge of the underlayment of base material by at least about ¾ inch.

9. The rectangular construction panel system of claim 1 wherein the water barrier layer overlaps the edge of the underlayment of base material by about 1 to 2 inches.

10. The rectangular construction panel system of claim 3 wherein the water barrier layer affixes to the underlayment of base material for the adjoining construction panels with at least one of: an adhesive and a mechanical anchor selected from the group consisting of a nail and a staple.

11. The rectangular construction panel system of claim 1 wherein an overlapping region of the water barrier layer is supplied with an adhesive for serving as an air barrier.

12. The rectangular construction panel system of claim 11 wherein the adhesive on the overlapping region of the water barrier layer is covered with a removable sheet of paper or cellophane.

13. The rectangular construction panel system of claim 11 wherein the adhesive is supplied to the overlapping region of the water barrier layer prior to installation of adjacent base materials.

14. The rectangular construction panel system of claim 13 wherein the adhesive is supplied to the overlapping region of the water barrier layer by spraying.

15. The rectangular construction panel system of claim 13 wherein the adhesive is supplied the overlapping region of the water barrier layer by brushing.

16. The rectangular construction panel system of claim 1, which further includes a radiant barrier layer coated thereon.

17. The rectangular construction panel system of claim 1, which further includes a radiant barrier layer laminated thereto.

18. A method for making a construction wall panel system more water resistant and less wasteful, said construction wall panel system including a plurality of rectangular base sheet materials, said method comprising:
(a) providing each of said plurality of rectangular base sheet materials of the construction wall panel system with a water barrier layer that overlaps all four lateral edges of the rectangular base sheet material, said water barrier layer being adhered to the rectangular base sheet material and designed to fully cover each horizontal and each vertical lateral edge of adjacent rectangular base sheet materials during installation of the construction wall panel system; and
(b) adhering at least some section of the overlapping water barrier layer of the rectangular base material to all lateral edges of the adjacent rectangular base materials.

19. The method of claim 18 wherein the water barrier layer adhered to each rectangular base sheet material overlaps all four outermost edges of the rectangular base sheet material by at least about ¾ inch.

20. The method of claim 18 wherein at least some section of the overlapping water barrier layer is provided with an adhesive covered with a removable sheet of paper or cellophane.
